(19) United States
(12) Patent Application Publication
(10) Pub. No.: US 2018/0171690 A1
(43) Pub. Date: Jun. 21, 2018

(54) HYDRAULIC HINGE HAVING AN INTEGRATED SOFT-CLOSURE SYSTEM

(71) Applicant: Oscar RODRIGUEZ RODRIGUEZ, Benito Juarez. Quintana Roo (MX)

(72) Inventor: Oscar RODRIGUEZ RODRIGUEZ, Benito Juarez. Quintana Roo (MX)

(21) Appl. No.: 15/576,854

(22) PCT Filed: Aug. 25, 2016
(86) PCT No.: PCT/MX2016/000087

§ 371 Date: Nov. 27, 2017

(30) Foreign Application Priority Data
Nov. 30, 2015 (MX) MX/U/2015/000585

(51) Int. Cl. E05D 7/04; E05F 3/20

(52) U.S. Cl. CPC E05D 7/0423; E05D 2007/0469; E05F 3/20

(57) ABSTRACT

A HYDRAULIC HINGE WITH AN INTEGRATED SOFT-CLOSING SYSTEM COMPRISING A MAIN COUPLING BASE, AN UPPER LID WITH TWO PLURALITIES HOLES, A PRIMARY UNION NECK DISPOSED IN BETWEEN THE MAIN COUPLING BASE AND THE BOWL-SHAPE PUSHING PIECE, A UNION LOCK THAT ATTACHES THE BOWL-SHAPE PUSHING PIECE AND THE MAIN COUPLING BASE, A BOWL-SHAPE PUSHING PIECE THAT INCLUDES TWO EXTREME RIGHT PLURALITIES HOLES AND EXTREME LEFT, A CLOSING SPRING DISPOSED IN BETWEEN THE MAIN COUPLING BASE AND THE BOWL-SHAPE PUSHING PIECE, WHICH ALONG THE PISTON PROVIDE TENSION AND SOFTNESS AT THE DOORS' CLOSING TIME, TWO STABILIZER BUSHINGS DISPOSED ON THE SLOW-CLOSING NECK, A SLOW-CLOSING NECK DISPOSED ON THE PRIMARY UNION NECK, A SLOW-CLOSING PIN DISPOSED ON THE MAIN COUPLING BASE, AND ATTACH TO THE EXTREME RIGHT PISTON TO BRING ABOUT THE SOFT-CLOSING FUNCTION, A HYDRAULIC PISTON DISPOSED ON THE MAIN COUPLING BASE, AN EASY INSTALLATION SUPPORT BASE DISPOSED ON THE MAIN COUPLING BASE, AN ATTACHMENT SUPPORT BASE, IS A BASE THAT ATTACHES THE HINGE FROM AN EXTREME AND IT ATTACHES WITH THE DOOR'S LATCH OR WHERE THE HINGE WILL BE INSTALLED.

### PREVIEWS OF THE INVENTION

NOWADAYS THERE IS KNOWLEDGE OF A GREAT VARIETY OF HINGES, FOR EXAMPLE, THE ADJUSTABLE HINGES OR THE ARTICULATED ONES; THE CONVENTIONAL ONES WITH BASIC FUNCTIONS, SUCH HINGES DO NOT COUNT WITH AN INTEGRATED SOFT-CLOSING SYSTEM. THE PREVIOUS EXAMPLES HAVE A LIMITATION, THE FACT THAT THEY ARE NOT REINFORCED WITH A RESISTANT MATERIAL, THAT MAKES THEM NOISY, AND WITH THE DAILY USE, THE DOORS LOSE THEIR FUNCTION, OR THEY DETERIORATE DUE TO THE EXPOSURE TO THE SUNRAYS, THE RAIN, AND THE SEA SALINITY.

THE PRESENT INVENTION SEEKS TO RESOLVE THIS TECHNICAL PROBLEM, BY ADDING A SOFT-CLOSING SYSTEM, WITH A RESISTANT MATERIAL TO THE SUNRAYS, THE RAIN, AND THE SALINITY.

### DESCRIPTION OF THE INVENTION

THE NOVELTY OF THIS INVENTION IS CLEARLY SHOWN IN THE DRAWINGS THAT ARE ATTACHED WITH THE PRESENT APPLICATION, AND ACCORDING WITH THE DESCRIPTION THAT WE IN-DETAIL DESCRIBED, THE ALPHA-NUMERIC REFERENCES DO BELONG TO EACH OF THE STRUCTURAL ELEMENTS THAT BELONG IN THIS INVENTION.

### BRIEF DESCRIPTION OF THE FIGURES

FIG. 1, IS A VIEW OF A SPLASH OF THE INTEGRATED HYDRAULIC SOFT-CLOSING HINGE SYSTEM AND THE STRUCTURAL PARTS THAT BELONG IN IT.

FIG. 2, IS A VIEW IN PERSPECTIVE OF THE INTEGRATED HYDRAULIC SOFT-CLOSING HINGE SYSTEM BUILDUP.

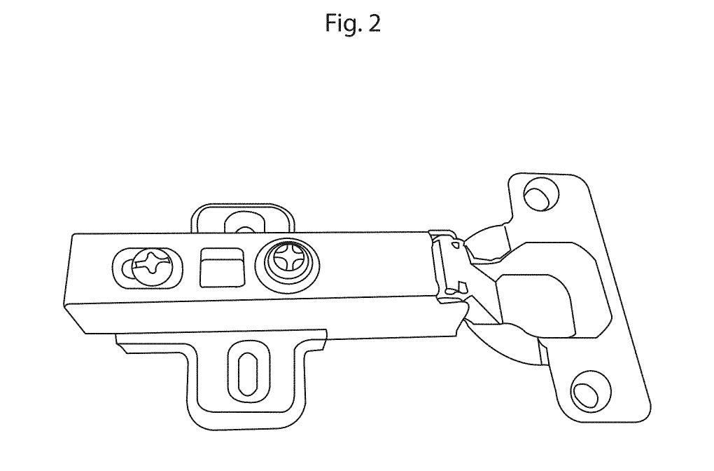

### INDETAILED DESCRIPTION OF THE INVENTION

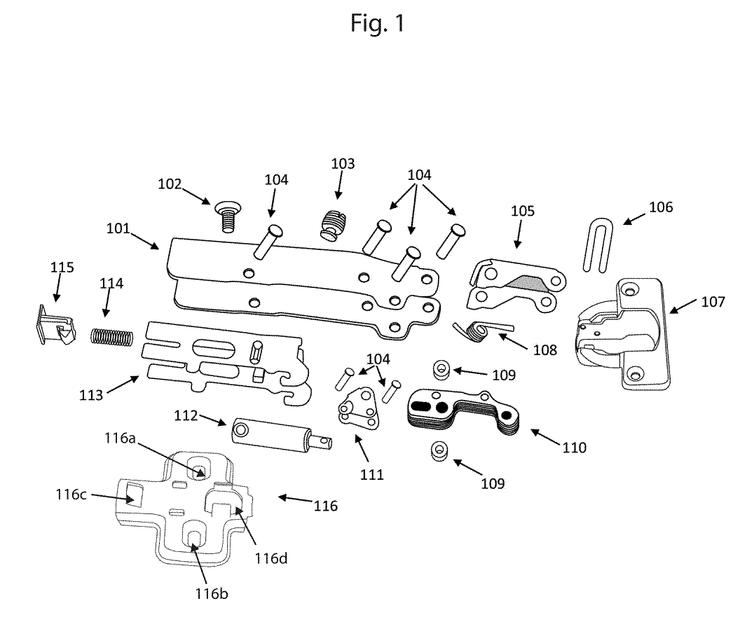

IN REFERENCE TO FIG. 1, THE INTEGRATED HYDRAULIC SOFT-CLOSING HINGE SYSTEM THAT COMPREHENDS A MAIN COUPLING BASE (101), AN UPPER LID WITH TWO-PLURALITIES HOLES (NOT ILLUSTRATED), A DEPTH ADJUSTER SCREW (102) SET ON THE UPPER RIGHT LID, A HEIGHT ADJUSTER SCREW SET ON THE EXTREME UPPER LEFT LID, (103), A FOUR-RIVET GUIDE SET LENGTHWISE ON THE MAIN COUPLING BASE (104), A PRIMARY UNION NECK (105) SET IN BETWEEN THE MAIN COUPLING BASE AND THE BOWL-SHAPE PUSHING PIECE (107), AND A UNION LOCK (106) THAT HOLDS THE BOWL-SHAPE PUSHING PIECE AND THE MAIN COUPLING BASE. ADDITIONALLY, A BOWL-SHAPE PUSHING PIECE (107) THAT COMPREHENDS EXTREME RIGHT TWO HOLE-PLURALITIES (107a) AND THE EXTREME UPPER LEFT (107b), A CLOSING SPRING (108) SET ON A EXTREME RIGHT MAIN BASE AND THE EXTREME LEFT BOWL-SHAPE PUSHING PIECE, WHICH TOGETHER WITH THE PISTON (112) PROVIDE TENSION AND THE SOFTNESS AT THE DOOR CLOSING TIME, TWO STABILIZER BUSHINGS (109) SET ON THE SLOW-CLOSED NECK, A SLOW-CLOSING NECK (110) SET ON A PRIMARY UNION NECK, A SLOW-CLOSING PIN (111) SET ON A MAIN COUPLING BASE (101) AND ATTACHES THE PISTON AT EXTREME RIGHT (112), SO IT BRINGS ABOUT A FUNCTION IN THE SOFT-CLOSING, WITH TWO ATTACHMENT RIVETS (111a), A HYDRAULIC PISTON (112) SET ON A MAIN COUPLING BASE, AN EASY-SETUP SUPPORT BASE (113) SET ON A MAIN COUPLING BASE, WHICH COMPREHENDS A LOCK ACTIVATOR SPRING (114) SET ON AN EASY-SETUP SUPPORT BASE, AN ATTACHMENT LOCK (115) SET ON THE EXTREME LEFT OF THE EASY-SETUP SUPPORT BASE, AN ATTACHMENT SUPPORT BASE (116) WITH TWO ASSEMBLY PLURALITIES HOLE, RIGHT LATERAL (116a) AND LEFT LATERAL (116b), AN EXTREME LEFT ASSEMBLY PLURALITY-HOLE (116c). AN EXTREME RIGHT ASSEMBLY PLURALITY-HOLE (116d) IS A BASE THAT ATTACHES THE HINGE FROM AN EXTREME POSITION AND ATTACHES IT WITH THE DOOR'S LATCH, OR WHERE THE HINGE WILL BE INSTALLED IT IS A HOLDING BASE TO THE OTHER EXTREME ATTACHMENT.

THE HYDRAULIC HINGE WITH THE INTEGRATED SOFT-CLOSING SYSTEM IS DESIGNED TO BE APPLIED ON FLAT DOORS, EACH PAIR SUPPORTS APPROXIMATELY LESS THAN 7 KG DOORS, THE INTEGRATED SOFT-CLOSING SYSTEM HELPS THE DOOR TO SLIDE SOFTLY AND QUIETLY ALONG THE GUIDE TOWARDS ITS TOTAL CLOSING, FURTHERMORE OF HAVING AN ABSORBED-SHOCK CLOSING, THE DESIGN ALLOWS ITS INSTALLATION ON DOORS WITH HEIGHTS NO HIGHER THAN A METER LONG AND WITH THICKNESS UP TO 60 CM THICK. THESE MEASUREMENTS ARE PROPORTIONAL TO THE DOOR'S WEIGHT, AND CONSIDERING THE USE ON A PAIR OF THESE HINGES. IN THE EVENT OF USING MORE HINGES, THE MEASUREMENTS CAN BE INCREASED, LIKE THE TOTAL WEIGHT OF THE LOAD.

THE INTEGRATED HYDRAULIC SOFT-CLOSING HINGE SYSTEM IS DESIGNED TO HAVE AN EASY INSTALLATION AND MOUNTING, THE INSTALLATION OF THE COMPLETE HINGE IS DONE INSIDE THE VANITY.

THE HYDRAULIC HINGE WITH AN INTEGRATED SOFT-CLOSING SYSTEM HAS A DESIGN THAT ALLOWS AN EASY HANDLING AND MOUNTING, IN VIRTUE THAT THE HINGE IS COMPREHENDED IN TWO PARTS WHICH ARE EASY TO ASSEMBLE AND TO ATTACH. THE FIRST PART IS THE MAIN COUPLING BASE (101) THAT IS FIXED TO THE FITMENT GIVING AN EASINESS IN THE MANIPULATION OF THE DOOR AT THE ASSEMBLY, THE SECOND PART IS THE BOWL-SHAPE PUSHING PIECE (107) WHOSE FUNCTION CONSISTS IN UNIFY THE DOOR TO THE FITMENT, BOTH PARTS ARE UNIFIED AND ATTACHED BY A UNION LOCK (106). THE DESIGN ON THE NECKS SUCH AS THE PRIMARY (105), LIKE THE CLOSING ONE (110), ALLOWS THE DOORS TO BE PLACED ON THE FITMENT'S FRAME, GIVING A COVER SPACE UP TO 16 MM. FROM THE CORNER OF THE FITMENT, THE INTEGRATED SPRING (108) HELPS THE DOOR'S CLOSING, AND WITH THE PISTON (112), THEY PROVIDE A NOISELESS CLOSING. THE MATERIAL

1. A HYDRAULIC HINGE WITH AN INTEGRATED SOFT-CLOSING SYSTEM COMPRISING:
A MAIN COUPLING BASF,
AN UPPER LID,
A DEEP ADJUSTER SCREW;
A HEIGHT ADJUSTER SCREW;
A FOUR-RIVETS GUIDE;
A PRIMARY UNION NECK;
AN UNION LOCK;
A BOWL-SHAPE PUSHING PIECE;
A CLOSING SPRING;
TWO STABILIZER BUSHINGS;
A SLOW CLOSING NECK;
A SLOW CLOSING PIN;
A HYDRAULIC PISTON;
A FAST INSTALLATION SUPPORT BASE; AND
AN ATTACH ENT SUPPORT BASE.

2. A HYDRAULIC HINGE WITH AN INTEGRATED SOFT-CLOSING SYSTEM ACCORDING TO claim 1, FURTHER COMPRISING:
AN UPPER LID WITH TWO PLURALITIES ASSEMBLY HOLES.

3. A HYDRAULIC HINGE WITH AN INTEGRATED SOFT-CLOSING SYSTEM ACCORDING TO claim 1, FURTHER COMPRISING:
A DEEP ADJUSTER ATTACHMENT SCREW.

4. A HYDRAULIC HINGE WITH AN INTEGRATED SOFT-CLOSING SYSTEM ACCORDING TO claim 1, FURTHER COMPRISING:
A HEIGHT ADJUSTER SCREW.

5. A HYDRAULIC HINGE WITH AN INTEGRATED SOFT-SYSTEM ACCORDING TO claim 1, FURTHER COMPRISING:
A FOUR-RIVET GUIDE.

6. A HYDRAULIC HINGE WITH AN INTEGRATED SOFT-CLOSING SYSTEM ACCORDING TO claim 1, FURTHER COMPRISING:
A PRIMARY UNION NECK.

7. A HYDRAULIC HINGE WITH AN INTEGRATED SOFT-CLOSING SYSTEM ACCORDING TO claim 1, FURTHER COMPRISING:
AN UNION LOCK.

8. A HYDRAULIC HINGE WITH AN INTEGRATED SOFT-CLOSING SYSTEM ACCORDING TO claim 1, FURTHER COMPRISING:
A BOWL-SHAPE PUSHING PIECE, WITH TWO EXTREME RIGHT PLURALITIES HOLES AND EXTREME LEFT.

9. A HYDRAULIC HINGE WITH AN INTEGRATED SOFT-CLOSING SYSTEM ACCORDING TO claim 1, FURTHER COMPRISING:
A CLOSING SPRING.

10. A HYDRAULIC HINGE WITH AN INTEGRATED SOFT-CLOSING SYSTEM ACCORDING TO claim 1, FURTHER COMPRISING:
A SLOW-CLOSING NECK WITH TWO STABILIZER BUSHINGS.

11. A HYDRAULIC HINGE WITH AN INTEGRATED SOFT-CLOSING SYSTEM ACCORDING TO claim 1, FURTHER COMPRISING:
A SLOW-CLOSING PIN WITH TWO ATTACHMENT RIVETS.

12. A HYDRAULIC HINGE WITH AN INTEGRATED SOFT-CLOSING SYSTEM ACCORDING TO claim 1, FURTHER COMPRISING:
A HYDRAULIC PISTON.

13. A HYDRAULIC HINGE WITH AN INTEGRATED SOFT-CLOSING SYSTEM ACCORDING TO claim 1, FURTHER COMPRISING:
A FAST INSTALLATION SUPPORT BASE.

14. A HYDRAULIC HINGE WITH AN INTEGRATED SOFT-CLOSING SYSTEM ACCORDING TO claim 13, FURTHER COMPRISING:
A LOCK'S ACTIVATOR SPRING.

15. A HYDRAULIC HINGE WITH AN INTEGRATED SOFT-CLOSING SYSTEM ACCORDING TO claim 13, FURTHER COMPRISING:
AN ATTACHMENT SUPPORT LOCK.

16. A HYDRAULIC HINGE WITH AN INTEGRATED SOFT-CLOSING SYSTEM ACCORDING TO claim 1, FURTHER COMPRISING:
AN ATTACHMENT SUPPORT BASE.

17. A HYDRAULIC HINGE WITH AN INTEGRATED SOFT-CLOSING SYSTEM ACCORDING TO claim 16, FURTHER COMPRISING:
TWO PLURALITIES ASSEMBLY HOLES, RIGHT LATERAL AND LEFT LATERAL.

18. A HYDRAULIC HINGE WITH AN INTEGRATED SOFT-CLOSING SYSTEM ACCORDING TO claim 16, FURTHER COMPRISING:
A EXTREME LEFT PLURALITY ASSEMBLY HOLE; A
AN EXTREME RIGHT PLURALITY ASSEMBLY HOLE.

19. A HYDRAULIC HINGE WITH AN INTEGRATED SOFT-CLOSING SYSTEM ACCORDING TO claim 13, FURTHER COMPRISING:
AN ATTACHMENT SUPPORT BASE.

20. A HYDRAULIC HINGE WITH AN INTEGRATED SOFT-CLOSING SYSTEM ACCORDING TO claim 15, FURTHER COMPRISING:
AN ATTACHMENT SUPPORT BASE.
